(19) United States
(12) Patent Application Publication
(10) Pub. No.: US 2026/0186710 A1
(43) Pub. Date: Jul. 2, 2026

(54) DEDICATED INTERFACE FOR FOLDING DATA FROM VOLATILE MEMORY (VM) DIES TO STACKED NON-VOLATILE MEMORY (NVM) DIE

(71) Applicant: Micron Technology, Inc., Boise, ID (US)

(72) Inventors: Tim Hollis, Meridian, ID (US); Akira Goda, Tokyo (JP); Sundararajan Sankaranarayanan, Fremont, CA (US); Jeffrey S. McNeil, Boise, ID (US); Suresh Rajgopal, San Diego, CA (US); Eric N. Lee, San Jose, CA (US); Xiangyu Tang, San Jose, CA (US)

(21) Appl. No.: 19/389,568

(22) Filed: Nov. 14, 2025

Related U.S. Application Data
(60) Provisional application No. 63/740,397, filed on Dec. 31, 2024.
(60) Provisional application No. 63/771,152, filed on Mar. 13, 2025.

(51) Int. Cl. G06F 3/06

(52) U.S. Cl. CPC G06F 3/0659; G06F 3/0611; G06F 3/0685

(57) ABSTRACT

A compute device comprising includes volatile memory (VM) dies stacked with a non-volatile memory (NVM) die and a logic die having control logic. A first plurality of through-silicon vias (TSVs) are formed through the one or more VM dies and the NVM die. In embodiments, the first plurality of TSVs are intercoupled through a plurality of microbumps. The control logic writes data to and reading data from the one or more VM dies through a first subset of the first plurality of TSVs. The control logic folds the data from the one or more VM dies to the NVM die through a second subset of the first plurality of TSVs that are fewer than the first subset and are dedicated to the folding of the data.

### CLAIM OF PRIORTY

The present application claims the benefit under 35 U.S.C. § 119(e) of U.S. Provisional Patent Application No. 63/740,397 filed Dec. 31, 2024, and Provisional Patent application No. 63/771,152 filed Mar. 13, 2025, which is incorporated by reference herein.

### TECHNICAL FIELD

Implementations of the disclosure relate generally to compute devices, and more specifically, relate to a dedicated interface for folding data from VM die(s) to NVM die stacked with the VM die(s).

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1A is an example high-level component diagram of a hybrid VM/NVM compute device (or system) implemented according to some embodiments.

FIG. 1B is an example flow chart illustrating a method for dedicating a subset of the through-silicon vias (TSVs) to folding data between VM dies and NVM die of the compute device (of system) of FIG. 1A according to some embodiments.

FIG. 2A is an example high-level component diagram of a hybrid VM/NVM compute device (or system) implemented with dedicated additional TSVs for folding the data according to some embodiments.

FIG. 2B is an example flow chart illustrating a method for using the dedicated additional TSVs (FIG. 2A) for folding the data between the VM dies and the NVM die of the compute device (or system) according to some embodiments.

FIG. 3A is an example high-level component diagram of a hybrid VM/NVM compute device (or system) implemented with a VM die dedicated as a buffer and to cause the data to be folded to the NVM die according to some embodiments.

FIG. 3B is an example flow chart illustrating a method for using the dedicated buffer VM die (FIG. 3A) for folding the data to the NVM die of the compute device (or system) according to some embodiments.

FIG. 4A is an example high-level component diagram of a hybrid VM/NVM compute device (or system) implemented with a VM die dedicated as a buffer and to cause the data to be folded from the VM die to the NVM die according to some embodiments.

FIG. 4B is an example flow chart illustrating a method for commanding the dedicated buffer VM die (FIG. 4A) to fold the data from the VM die to the NVM die of the compute device (or system) according to some embodiments.

FIG. 5A is an example high-level component diagram of a hybrid VM/NVM compute device (or system) implemented with a VM die face-down towards the NVM die and including a physical interface therebetween according to some embodiments.

FIG. 5B is example flow chart illustrating a method for folding data from the VM die to the NVM die over the physical interface according to some embodiments.

FIG. 6A is an example high-level component diagram of a hybrid VM/NVM compute device (or system) implemented with a NVM die face-down towards a VM die and including a physical interface therebetween according to some embodiments.

FIG. 6B is example flow chart illustrating a method for folding data from the VM die to the NVM die over the physical interface according to some embodiments.

FIG. 7 is an example high-level component diagram of a hybrid VM/NVM compute device (or system) implemented with a sideband interconnect between application-specific integrated circuits (ASICs) so that data can be folded from a VM die to a NVM die according to some embodiments.

FIG. 8 illustrates an example computing system that includes a memory sub-system implemented in accordance with some implementations of the present disclosure.

FIG. 9 is a block diagram illustrating a system for performing AI model inference operations using memory devices and/or host systems implemented in accordance with aspects of the present disclosure.

FIG. 10 is a block diagram of an example computer system in which implementations of the present disclosure may operate.

### DETAILED DESCRIPTION

Aspects of the present disclosure are directed to employing, within a compute device or system, a dedicated interface for folding data from VM die(s) to a NVM die stacked with the VM die(s). A memory sub-system can include one or more storage devices, memory modules, and/or hybrid storage devices and memory modules. Examples of storage devices and memory modules are described below. In general, a host system can utilize a memory sub-system that includes one or more components, such as memory devices that store data. The host system can provide data to be stored at the memory sub-system and can request data to be retrieved from the memory sub-system.

A memory sub-system may utilize one or more memory devices, including any combination of the different types of non-volatile memory devices and/or volatile memory devices, to store the data provided by the host system. In some implementations, non-volatile memory devices may be provided by negative-and (NAND) type flash memory devices. A non-volatile memory device is a package of one or more dies. Each die (“logical unit”) may include one or more planes. For some types of non-volatile memory devices (e.g., NAND devices), each plane may include a set of physical blocks. Each block may in turn include a set of pages. Each page includes a set of memory cells. A memory cell is an electronic circuit that stores one or more bits of information.

A memory device may include multiple memory cells arranged in a two-dimensional grid. The memory cells can be formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Depending on the cell type, each memory cell may store one or more bits of information and has various logic states that correlate to the number of bits being stored. The logic states may be represented by binary values, such as “0 ” and “1”, or combinations of such values. A memory cell may be programmed (written to) by applying a certain voltage to the memory cell, which results in an electric charge being held by the memory cell, thus allowing modulation of the voltage distributions produced by the memory cell. A set of memory cells referred to as a memory page may be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation may be performed by comparing the measured threshold voltages (Vt) exhibited by the memory cell to one or more reference voltage levels in order to distinguish between two logical levels for single-level cell (SLCs) and between multiple logical levels for multi-level cells. Each logical level may be translated into a corresponding binary representation of the content of the memory cell.

Memory access operations (e.g., a read operation, a programming (write) operation, an erase operation, etc.) may be executed with respect to sets of the memory cells, e.g., in response to receiving memory access commands from the host. A memory access operation may specify the requested memory access operation (e.g., write, erase, read, etc.) and a logical address, which the memory sub-system would translate to a physical address identifying a set of memory cells (e.g., a block).

In some implementations, memory sub-systems can be used to store data used to train machine learning (ML) and artificial intelligence (AI) frameworks, as well as data on which the ML/AI framework can be executed. An ML/AI framework can include a model, which is a representation of a neural network designed to produce one or more outputs responsive to one or more inputs. In such frameworks, the amount of data used to train the ML models can be extremely large and a training process cycle can be executed multiple times (e.g., multiple “epochs”). For example, an ML framework used to classify an image as being a particular type of image (e.g., an image of a person, an animal, a type of animal, etc.) can utilize a large data set of stored images that are repeatedly processed in multiple epoch cycles to train the model. Similarly, data sets used for testing and/or inference stages of a ML/AI workflow can include very large amounts of data. For example, the inference stage utilizes the trained model, which is very large and requires significant storage, to make predictions or decisions on new input data. This process can include processing the input data, feeding it into the model, and post-processing the output of the model if necessary.

In order to process the large amounts of data, many host systems executing ML/AI frameworks include multiple processing units or compute devices (e.g., graphics processing units (GPUs) and/or central processing units (CPU)) which can process multiple threads/streams in parallel. During the inference phase, these processing units utilize relatively small chunks of data (e.g., tens or hundreds of bytes) from a significantly larger corpus of data (e.g., many gigabytes or terabytes) stored at a memory sub-system. For example, the inference phase may involve walking through multiple graph nodes in order to determine the value of a vertex element and identify its connections.

In some embodiments, the input data can be loaded from the memory sub-system to a local host memory co-located with the processing units executing the ML/AI framework. This host memory can be implemented using high bandwidth memory (HBM) devices that offer extremely high (i.e., fast) performance, but have relatively low storage capacities. In embodiments, multiple processing units or compute devices (GPUs and/or CPUs) can be connected to a shared memory pool, such that each processing unit can have its own local memory and can also access, over a high-speed interconnect, the memory that is local to other processing units. However, the local memory accesses would exhibit much lower latency as compared to the remote memory accesses.

Thus, memory capacity is one of the biggest challenges faced by enterprise deployment of AI/ML models. Various solutions involve increasing the number of dies stacked in HBM packages accessible by a processing unit or compute device (e.g., a GPU) and implementing various non-uniform memory access (NUMA) schemes in which a processing unit, in addition to its local memory, may also access a local memory of another processing unit.

However, these and other solutions fail to adequately satisfy the growing memory capacity requirements while delivering the requisite memory access bandwidth and latency, not to mention containing the costs. For example, bandwidth is limited over through-silicon vias (TSVs) that interconnect stacked VM (or HBM) dies and at least one NVM die. Although data can be quickly written to the VM/HBM dies, folding that data into the NVM die takes up bandwidth over the TSVs of the stacked hybrid VM/NVM memory, negatively impacting the bandwidth and latency involved with writing data to the VM dies. Data folding refers to the process of intelligently transferring or reorganizing data between volatile memory (e.g., DRAM, HBM) and non-volatile memory (e.g., NAND flash, Optane, magnetoresistive RAM (MRAM), or other storage-class memory) to optimize performance, endurance, and power efficiency. The rate of folding data into slower-access NVM dies is expected to be significantly slower than the rate of buffering data into faster-access VM dies.

Aspects of the present disclosure address the above and other deficiencies by integrating a dedicated interface within, or in addition to, an original plurality of TSVs over which to fold data from the VM dies that are stacked with at least one NVM die according to various embodiments. For example, in some embodiments, a compute device (or system) uses a first subset of the TSVs over which to write data to and read data from the VM dies and a second subset of the TSVs over which to fold data from the VM dies to the NVM die. In some cases, the first subset of TSVs is a majority of the TSVs, such as all of the channels except for one. The second subset of TSVs, which are dedicated to folding data, can make up a single channel (or at least much fewer channels than the majority of TSVs) configured to transfer the data at a slower rate than that of the first subset of TSVs.

According to other embodiments, instead of dedicating a subset of the TSVs to the folding, the compute device can be configured with a second plurality of TSVs (in addition to the original plurality of TSVs) so that the original plurality of TSVs can be dedicated to writing data to and reading data from the VM dies while the second plurality of TSVs can be dedicated to folding data from the VM dies to the NVM dies. In embodiments, the original plurality of TSVs form a plurality of channels and the second plurality of TSVs form a single channel configured to transfer the data at a slower rate than that of the original plurality of TSVs.

In related embodiments, a single VM die that is closest to the NVM die is dedicated as a buffer from which the folding occurs. In such embodiments, a controller (or control logic) of the compute device (or system) writes data to the dedicated VM die but can also transmit a command to the VM die. The command, for example, can include a physical address and be configured to cause the dedicated VM die to fold the data, over the second plurality of TSVs, to the physical address of the NVM die.

In some embodiments, at least one of the VM dies (e.g., the one that is closest to the NVM die) is oriented face-down towards the NVM die within the hybrid VM/NVM stack of memory. In this way, a physical interface can directly interconnect the closest VM die to the NVM die and additional TSVs (which are more expensive to include) can be avoided. The physical interconnect can include, for example, microbumps, a plurality of metal pillars, or a hybrid bonded connection. While mixing and matching physical interconnect type, practicalities suggest that they will match, for example, if microbumps are used for the TSVs, microbumps may likely also be used for the physical interconnect as well. In such embodiments, the command can still be sent when writing data to the dedicate VM die so that the VM die can fold the data directly to the NVM die, as will be explained in more detail. In a similar embodiment, the NVM die is located at the top of the VM die stack and is positioned face-down towards the closest VM die (e.g., the top-most VM die of the stack) so that a similar physical interconnect can couple the closets VM die directly to the NVM die without use of additional TSVs.

Through employing any of the disclosed embodiments of dedicating an interface to folding data between VM dies and a stacked NVM die, the high bandwidth and low latency required for writing data to the VM dies is maintained while allowing timed folding of the data from one or more VM dies to the NVM die in a hybrid VM/NVM stack of memory. In this way, the data folding need not tie up the TSVs (and other interface means) that interconnect the VM dies and the NVM dies for higher speed (e.g., HBM speeds) of writing data to HBM dies. These and other advantages will be apparent to those skilled in the art of memory sub-systems.

In some implementations, one or more hybrid compute devices implemented in accordance with one or more aspects of the present disclosure may be packaged into a specified form factor, e.g., a form factor utilized by non-volatile memory devices, a form factor utilized by storage devices (such as solid state drives (SSDs)), or the like. Using a standard memory form factor would facilitate seamless integration of the device into various computing systems, such as, e.g., Internet-of-Things (IoT) devices, wearable or portable computing devices, automotive computing devices, enterprise compute systems, or enterprise storage systems, etc.

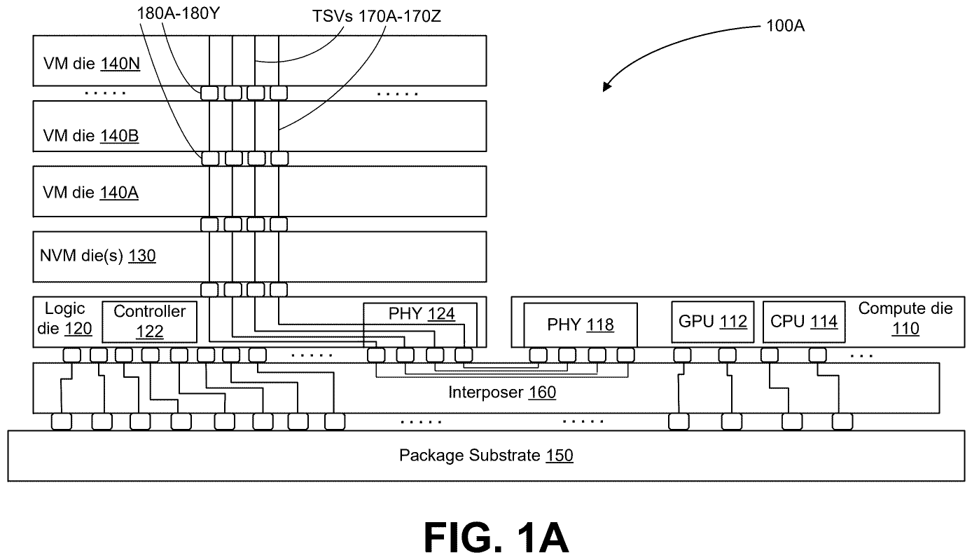

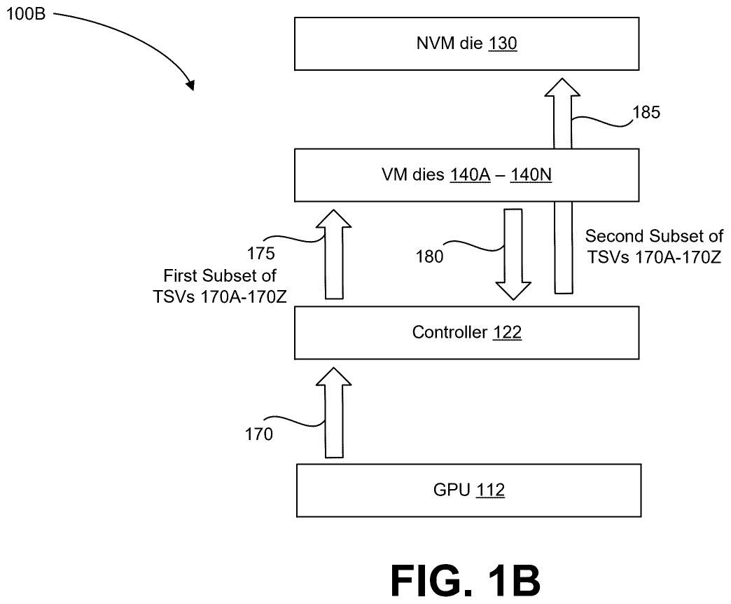

FIG. 1A is an example high-level component diagram of a hybrid VM/NVM compute device 100A (or system) implemented according to some embodiments. As schematically illustrated by FIG. 1A, the hybrid memory and compute device 100A may be implemented as an integrated circuit (IC) that includes a compute die 110, a logic die 120, one or more NVM dies 130, and one or more volatile memory (VM) dies 140A-140N, all the dies being disposed on a common package substrate 150.

Disposed on the compute die 110 are one or more processing units (e.g., one or more GPUs 112 and/or one or more CPUs 114) and their respective auxiliary circuitry, including local memory, input/output (I/O) interfaces, etc., which are omitted from FIG. 1A for clarity and conciseness. While a single compute die 110 is shown in FIG. 1A for clarity and conciseness, in various other implementations, device 100A may include two or more compute dies 110.

In some implementations, an NVM die 130 may be represented by a NAND die. In some implementations, one or more NVM dies 130 may be single-level cell (SLC) NAND dies, which exhibit better endurance and lower access latency as compared, e.g., to multiple-level cell (MLC), triple-level cell (TLC), or quad-level cell (QLC) dies. In some implementations, a VM die 140 may be represented by an HBM dynamic random access memory (DRAM) die. While a single logic die 120 is shown in FIG. 1A for clarity and conciseness, in various other implementations, device 100A may include two or more logic dies 120.

The stacked VM dies 140, NVM dies 130, and the logic die 120 may be interconnected by through-silicon vias (TSVs) 170A-170Z and microbumps 180A-180Y. For example, the TSVs 170A-170Z may be formed through the VM dies 140A-140N as well as through the one or more NVM dies 130 while the microbumps 180A-180Y interconnect the TSVs 170A-170Z in between the VM/NVM dies. A TSV is a high-performance interconnect technique that utilizes a vertical electrical connection (via) that passes through a silicon wafer or die. “Microbumps” are small raised spheres which are made of a conductive material and connect a die with another die or a substrate, thus serving as conduits delivering electrical signals from one part of a chip to another, e.g., in these examples, through memory dies that are stacked together.

The components disposed on the compute die 110 may communicate with the components disposed on the logic die 120, components disposed on the NVM dies 130, and/or components disposed on the VM dies 140A-140N via respective physical interfaces (PHYs) 118, 124 interconnected by the interposer 160. An interposer is an electrical interface routing electrical signals between one socket or connection and another socket or connection. Thus, the memory access requests issued by the processing units residing on the compute die 110 may be transmitted via the interposer 160 to the logic die 120.

In embodiments, the controller 122 (or other control logic, such as a logic device) is disposed on the logic die 120 and configured to manage the NVM dies 130 and/or the VM dies 140. In some implementations, the controller 122 may implement a common logical address space for the VM dies 140A-140N and the NVM dies 130A-130K. Accordingly, the controller 122 may perform logical-to-physical (L2P) address translation based on the common logical address space.

In some implementations, no address translation (other than offsetting by a predefined value) may be required for the logical addresses that are below the upper limit of the user-addressable capacity of the VM dies 140A-140N. In other words, the logical addresses within the user-addressable capacity of the VM dies 140A-140N will directly (e.g., with an optional offset) reference respective memory locations on the VM dies 140A-140N, while the logical addresses exceeding the upper limit of the user-addressable capacity of the VM dies 140A-140N:
if LBA <=NVM Capacity then PA_{VM}=LBA+Offset
   else PA_{NVM}=L2P[LBA]
where LBA is the logical block address,
NVM Capacity is the user-addressable capacity of the VM dies 140A-140N,
PA_{VM} is the physical address of a TU residing on the VM dies 140A-140N,
Offset is the optional offset to be applied to the logical addresses,
PA_{NVM} is the physical address of a TU residing on the NVM dies 130,
L2P[. . . ] is the logical-to-physical (L2P) address translation table, and
L2P[LBA] is the physical address corresponding to the specified LBA.

In an illustrative example, the total user-addressable capacity of the VM dies 140A-140N may be 40 GB, while the total user-addressable capacity of the NVM dies 130 may be 128 GB. Thus, the memory access requests initiated by the compute die 110 with respect to transfer units (TUs) (such as memory pages, blocks, etc.) referenced by logical addresses below the upper limit of the user-addressable capacity of the VM dies 140A-140N may be satisfied directly via the physical interfaces 118 and 124 accessing the VM dies 140A-140N.

Conversely, memory access requests initiated by the compute die 110 with respect to TUs referenced by the logical addresses exceeding the upper limit of the user-addressable capacity of the VM dies 140A-140N may be sent to the controller 122 (or control logic), which may translate these logical addresses to corresponding physical addresses of TUs residing on the NVM dies 130. The address translation may be facilitated by a logical-to-physical (L2P) table, which may be indexed by the logical addresses so that each entry of the table would store a physical address corresponding to the logical address identifying the entry: PA_{NVM}=L2P[LBA].

In some embodiments, to avoid negatively impacting bandwidth and latency of the TSVs 170A-170Z and microbumps 180A-180Y, the controller 122 (or control logic) can write data to and read data from the one or more VM dies 140A-140N through a first subset of the TSVs 170A-170Z, e.g., all but one channel of the TSVs such as TSVs 180A-180W. The controller 122 can further fold the data from the one or more VM dies 140A-140N to the NVM die 130 through a second subset of the first plurality of TSVs that are fewer than the first subset and are dedicated to the folding of the data. For example, in some embodiments, the second subset of the TSVs include a single set of TSVs such as TSVs 180X-180Y. In this way, only a small portion of the TSVs are subjected to slower data rates, latency, and process of data folding.

FIG. 1B is an example flow chart illustrating a method 100B for dedicating a subset of the through-silicon vias (TSVs) to folding data between VM dies and NVM die of the compute device (of system) of FIG. 1A according to some embodiments. The method 100B may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 100B is performed by the controller 122 of FIG. 1A or other control logic that may not be a full controller.

Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 170, the processing logic receives data from the GPU 112, e.g., over one or more physical interfaces that interconnect the compute die 110 with the logic die 120.

At operation 175, the processing logic writes data over a first subset of the TSVs 170A-170Z to the one or more VM dies 140A-140N.

At operation 180, to fold the data previously written to the VM dies 140A-140N, the processing logic reads the data back out of the one or more VM dies 140A-140N over the second subset of the TSVs 170A-170Z. In some embodiments, the data will be read out of one of the VM dies 140A-140N.

At operation 185, to complete the folding of the data, the processing logic folds the data from controller 122, over the second subset of the TSVs 170A-170Z, to the NVM die 130 which represents one or more NVM dies. In some embodiments, the second subset of the TSVs makes up a single channel while the first subset of the TSVs makes up the remainer (or majority) of the TSVs.

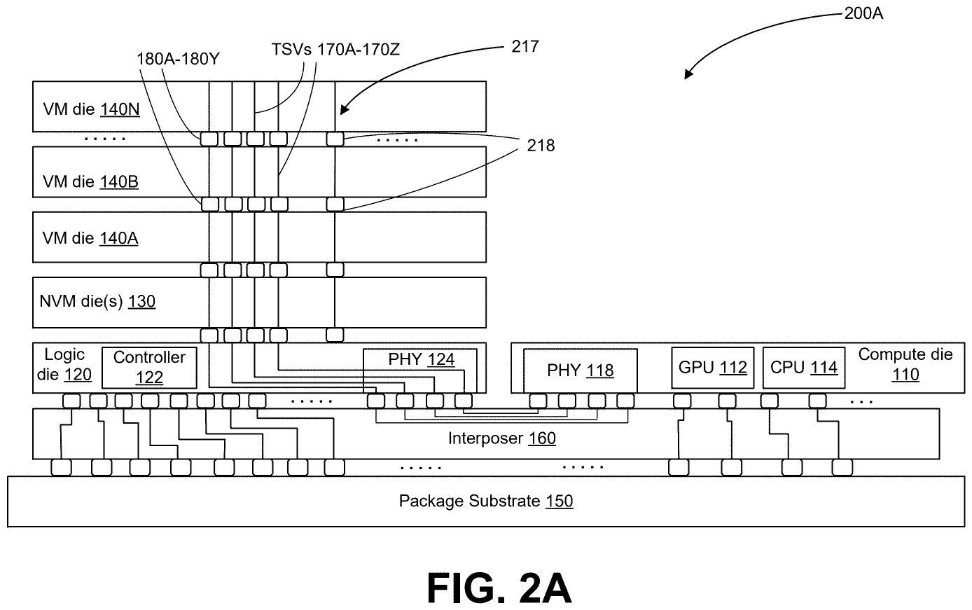

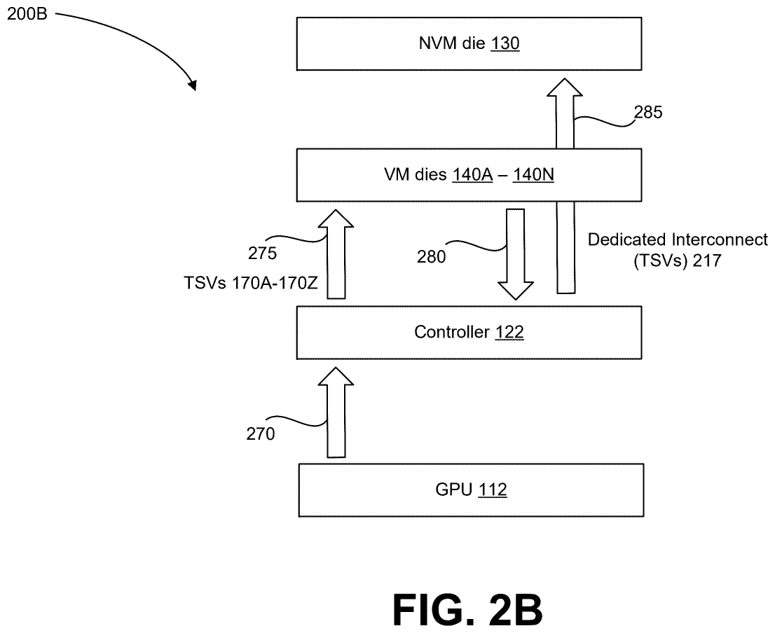

FIG. 2A is an example high-level component diagram of a hybrid VM/NVM compute device 200A (or system) implemented with dedicated additional TSVs for folding the data according to some embodiments. For example, as an extension to the compute device 100A of FIG. 1A, the compute device 200A can include a second plurality of TSVs 217 formed through the VM dies 140A-140N and the NVM die 130. The compute device 200A can further include a second plurality of microbumps 218 to interconnect the second plurality of TSVs 217. In embodiments, the controller 122 (or control logic) is configured to perform the folding through the second plurality of TSVs, e.g., instead of the original TSVs 170A-170Z. In embodiments, the first plurality of TSVs 170A-170Z form a plurality of channels and the second plurality of TSVs 217 form a single channel configured to transfer the data at a slower rate than that of the first plurality of TSVs.

FIG. 2B is an example flow chart illustrating a method 200B for using the dedicated additional TSVs (FIG. 2A) for folding the data between the VM dies and the NVM die of the compute device (or system) according to some embodiments. The method 200B may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 200B is performed by the controller 122 of FIG. 2A or other control logic that may not be a full controller.

Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 270, the processing logic receives data from the GPU 112, e.g., over one or more physical interfaces that interconnect the compute die 110 with the logic die 120.

At operation 275, the processing logic writes data over the TSVs 170A-170Z to the one or more VM dies 140A-140N.

At operation 280, to fold the data previously written to the VM dies 140A-140N, the processing logic reads the data back out of the one or more VM dies 140A-140N over the second plurality of TSVs 217, e.g., which is a dedicated interface in addition to the original or first TSVs 170A-170Z. In some embodiments, the data will be read out of one of the VM dies 140A-140N.

At operation 285, to complete the folding of the data, the processing logic folds the data from controller 122 (or control logic), over the second plurality of TSVs 217, to the NVM die 130 (which represents one or more NVM dies).

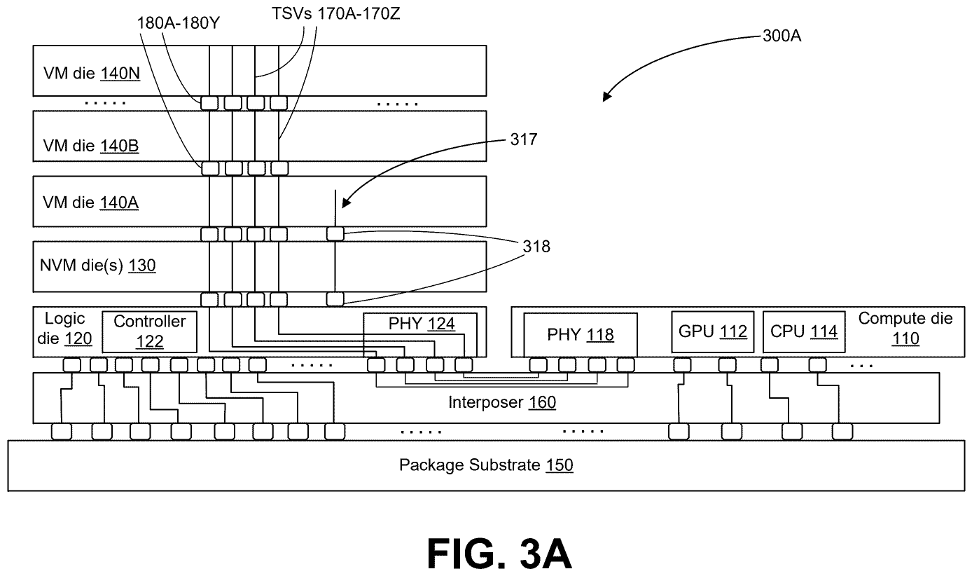

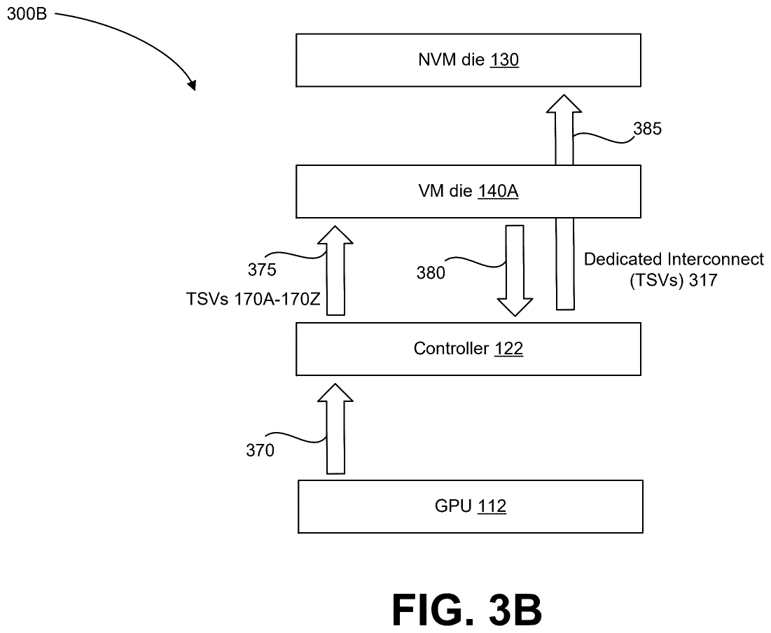

FIG. 3A is an example high-level component diagram of a hybrid VM/NVM compute device 300A (or system) implemented with a VM die dedicated as a buffer and to cause the data to be folded to the NVM die according to some embodiments. Different from the compute device 200A of FIG. 2A, the compute device 300A includes a second plurality of TSVs 317 formed through the NVM die 130 and a first VM die 140A, of the one or more VM dies, that is stacked physically closest to the logic die 120. In this way, the first VM die 140A can act as a dedicated buffer from which to fold data to the NVM die 130. In embodiments, the first plurality of TSVs 170A-170Z are interconnected through a first plurality of microbumps 180A-180Y and the second plurality of TSVs 317 are interconnected through a second plurality of microbumps 318.

FIG. 3B is an example flow chart illustrating a method 300B for using the dedicated buffer VM die (FIG. 3A) for folding the data to the NVM die of the compute device (or system) according to some embodiments. The method 300B may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 300B is performed by the controller 122 of FIG. 3A or other control logic that may not be a full controller.

Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 370, the processing logic receives data from the GPU 112, e.g., over one or more physical interfaces that interconnect the compute die 110 with the logic die 120.

At operation 375, the processing logic writes data over the first plurality of TSVs 170A-170Z to the dedicated VM dies 140A, e.g., which serves as a buffer VM die.

At operation 380, to fold the data previously written to the VM die 140A, the processing logic reads the data back out of the dedicated VM die 140A over the second plurality of TSVs 317, e.g., which is a dedicated interface in addition to the original or first TSVs 170A-170Z.

At operation 385, to complete the folding of the data, the processing logic folds the data from controller 122 (or control logic), over the second plurality of TSVs 317, to the NVM die 130 (which represents one or more NVM dies).

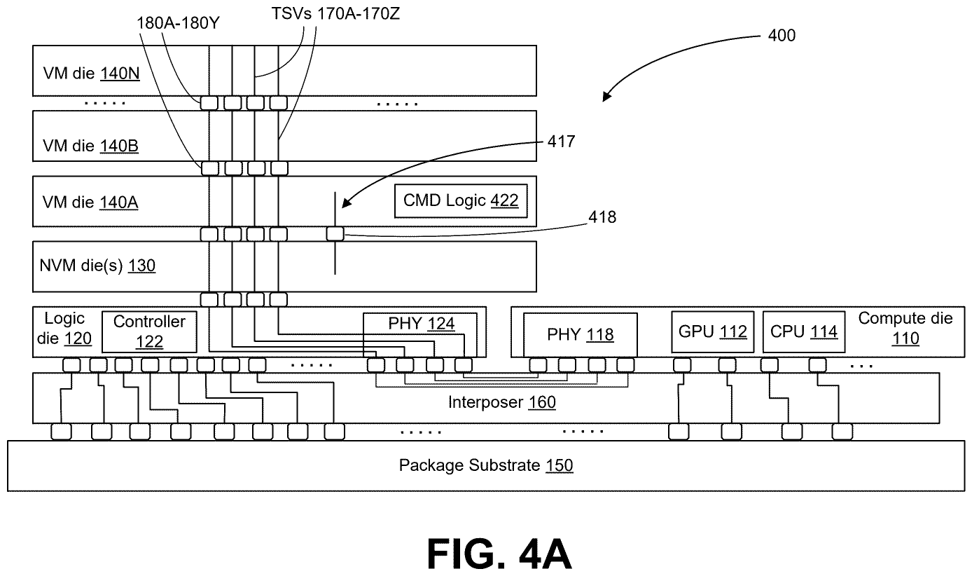

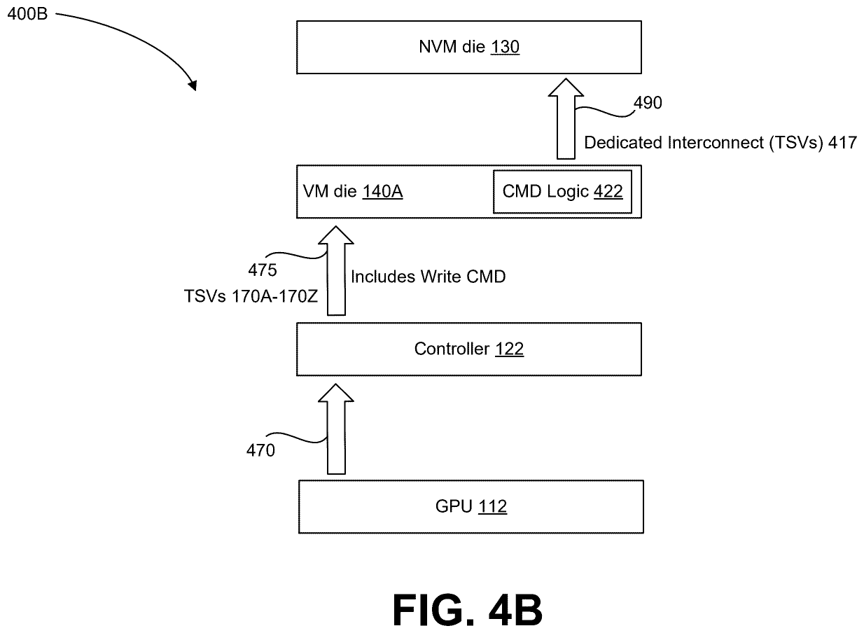

FIG. 4A is an example high-level component diagram of a hybrid VM/NVM compute device 400A (or system) implemented with a VM die dedicated as a buffer and to cause the data to be folded from the VM die to the NVM die according to some embodiments. Different from the compute device 200A of FIG. 2A, the compute device 400A includes a second plurality of TSVs 417 formed through the NVM die 130 and a first VM die 140A, of the one or more VM dies 140A-140N, that is stacked physically closest to the logic die 120. In this way, the first VM die 140A can act as a dedicated buffer from which to fold data to the NVM die 130. In embodiments, the first plurality of TSVs 170A-170Z are interconnected through a first plurality of microbumps 180A-180Y and the second plurality of TSVs 417 are interconnected through a second plurality of microbumps 418.

In some embodiments, the first VM die 140A also includes command logic 422, which is configured to recognize a write command received from the controller 122 (or control logic) and execute the write command to fold the data, received over the first plurality of TSVs 170A-170Z, to the NVM device 130. For example, the command logic 422 can include a state machine configured to determine (or identify) a physical address within the write command and direct a write (e.g., folding) of the data at the NVM device 130. In some embodiments, the command logic 422 identifies the write command, extracts the physical address from the write command, and folds the data, over the second plurality of TSVs 417, to a location associated with the physical address in the NVM die.

In embodiments, therefore, the controller 122 selects, from a command table, the write command that is to direct the first VM die 140A to perform folding of the data to the NVM die 130. The controller 122 can then populate the write command with the physical address to which the data is to be folded in the NVM die 130. In some embodiments, the controller 122 performs a logical-to-physical address translation to determine the physical address in the first place. In some embodiments, the second plurality of TSVs 417 are also formed through one or more additional VM dies 140B-140N, and transmitting the write command is to the one or more additional VM dies 140B-140N, which are also configured to fold the data to the NVM die 130. In such embodiments, the plurality of second TSVs 417 would also extend through the one or more additional VM dies 140B-140N with additional corresponding microbumps.

FIG. 4B is an example flow chart illustrating a method 400B for commanding the dedicated buffer VM die (FIG. 4A) to fold the data from the VM die to the NVM die of the compute device (or system) according to some embodiments. The method 400B may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 400B is performed by the controller 122 of FIG. 4A. In embodiments, the method 400B is also performed by the command logic 422 or other control logic that may not be a full controller.

Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 470, the processing logic receives data from the GPU 112, e.g., over one or more physical interfaces that interconnect the compute die 110 with the logic die 120.

At operation 475, the processing logic writes data over the first plurality of TSVs 170A-170Z to the dedicated VM dies 140A, e.g., which serves as a buffer VM die. In embodiments, the processing logic transmits the data with a write command that includes a physical address in the NVM device 130, which describes a destination location for folding the data to the NVM device 130.

At operation 490, to complete the folding of the data, the processing logic (e.g., the CMD logic 422) folds the data, over the second plurality of TSVs 417, to the physical address of the NVM die 130.

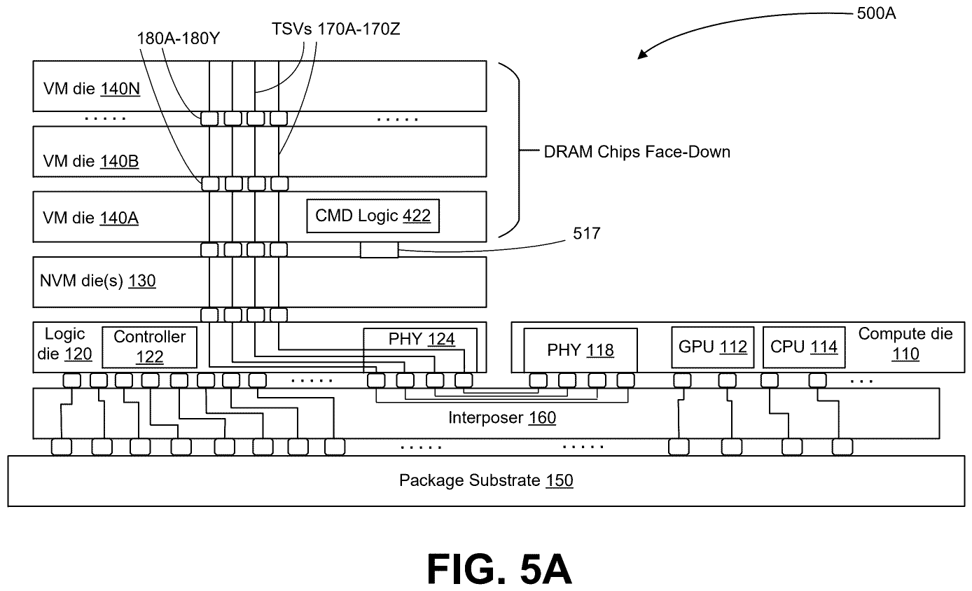

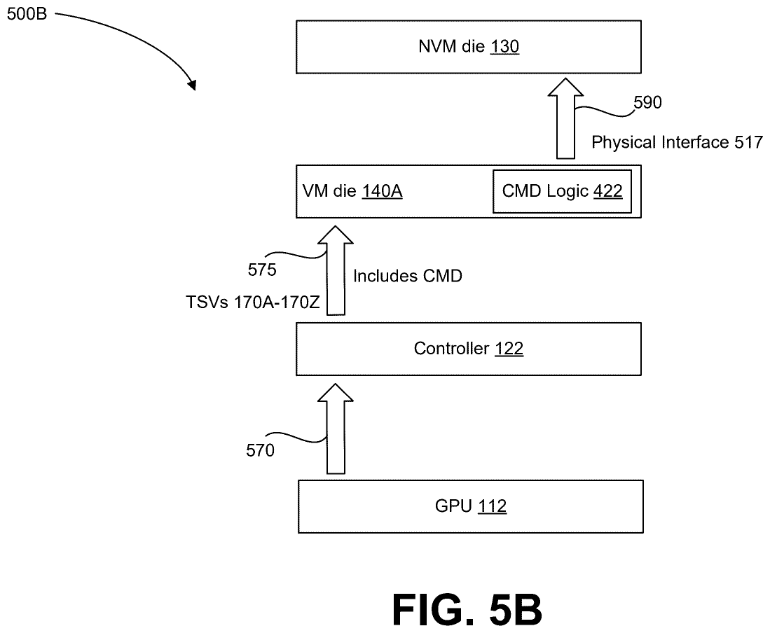

FIG. 5A is an example high-level component diagram of a hybrid VM/NVM compute device 500A (or system) implemented with a VM die face-down towards the NVM die and including a physical interface therebetween according to some embodiments. Although having similarities to the compute device 400A of FIG. 4A, the plurality of VM dies 140A-140N of the compute device 500A are face-down towards the NVM die 130, which is oriented face up towards the VM dies 140A-140N. Thus, at least the first VM die 140A, which is physically closest to the logic die 120, is face-down towards the NVM die 130. Being “face-down” in this context means that the DRAM chips are oriented with a top of the silicon of each chip oriented towards to the NVM die 130.

In such embodiments, instead of including additional TSVs, a physical interconnect 517 is coupled (or connected) between the NVM die 130 and the first VM die 140A, of the plurality of VM dies, stacked physically closest to the NVM die 130. Because the tops of the DRAM chips of the first VM die 140A and the top of the memory chip (e.g., NAND chip) of the NVM die 130 will be physically adjacent and close to each other, the physical interconnect 517 can directly connect the first VM die 140A to the NVM die 130 without TSVs. For example, in various embodiments, the physical interconnect 517 is implemented with microbumps, a plurality of metal pillars, or a hybrid bonded connection, among others that would be apparent to those skilled in the art of semiconductor interconnects. While mixing and matching physical interconnect type, practicalities suggest that they will match, for example, if microbumps are used for the TSVs, microbumps may likely also be used for the physical interconnect 517 as well. In this way, when the first VM die 140A folds the data into the NVM die 130, the data is passed directly over the physical interconnect 517 to the NVM die 130 from the first VM die 140A. More specifically, the command logic 422 is configured to identify the write command, extract the physical address from the write command, and fold the data, over the physical interconnect 517, to a location associated with the physical address in the NVM die 130.

FIG. 5B is example flow chart illustrating a method 500B for folding data from the VM die to the NVM die over the physical interface 517 according to some embodiments. The method 500B may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 500B is performed by the controller 122 of FIG. 5A or other control logic that may not be a full controller. In embodiments, the method 500B is also performed by the command logic 422.

Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 570, the processing logic receives data from the GPU 112, e.g., over one or more physical interfaces that interconnect the compute die 110 with the logic die 120.

At operation 575, the processing logic writes data over the first plurality of TSVs 170A-170Z to the dedicated VM dies 140A, e.g., which serves as a buffer VM die. In embodiments, the processing logic transmits the data with a write command that includes a physical address in the NVM device 130, which describes a destination location for folding the data to the NVM device 130.

At operation 590, to complete the folding of the data, the processing logic (e.g., the CMD logic 422) folds the data, over the physical interface 517, to the physical address of the NVM die 130.

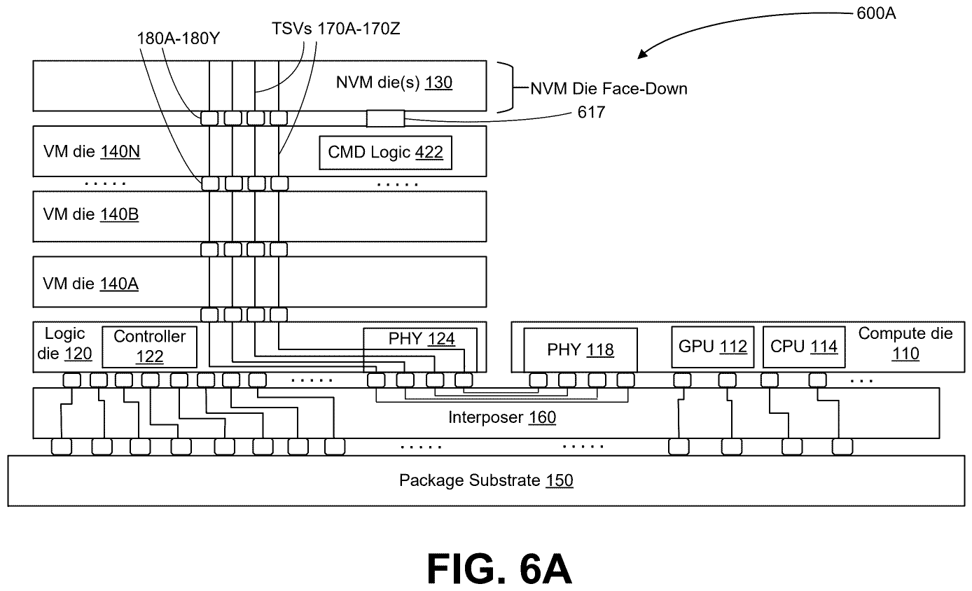

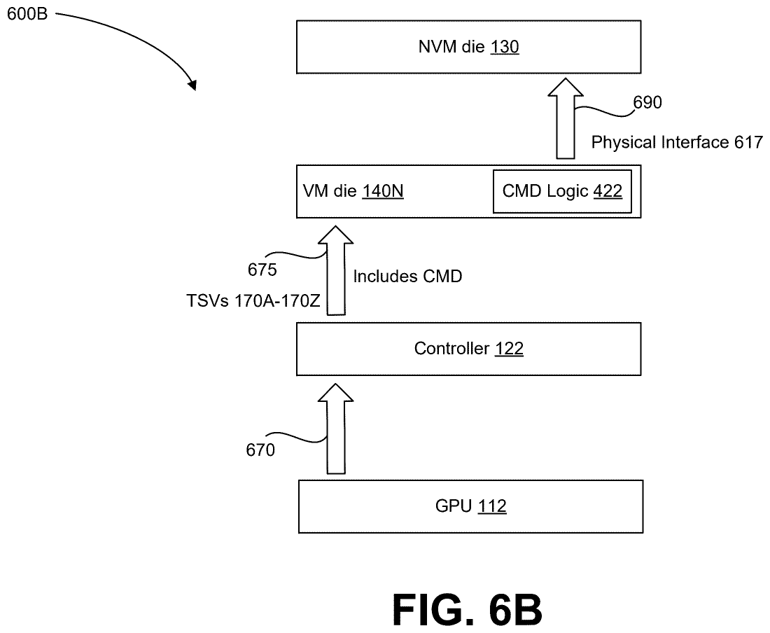

FIG. 6A is an example high-level component diagram of a hybrid VM/NVM compute device 600A (or system) implemented with a NVM die face-down towards a VM die and including a physical interface therebetween according to some embodiments. Related to the embodiment of FIG. 6A, the NVM die 130 (instead of the VM dies) is stacked face-down on the VM dies 140A-140N. Thus, the top of the memory chip of the NVM die 130 is oriented towards a final VM die 140N of the one or more VM dies 140A-140N.

In such embodiments, instead of including additional TSVs, a physical interconnect 617 is coupled (or connected) between the NVM die 130 (e.g., the top of the memory chip) and the final VM die 140N, of the plurality of VM dies, stacked physically closest to the NVM die 130. Because the tops of the DRAM chips of the final VM die 140N and the top of the memory chip (e.g., NAND chip) of the NVM die 130 will be physically adjacent and close to each other, the physical interconnect 617 can directly connect the final VM die 140N to the NVM die 130 without TSVs. For example, in various embodiments, the physical interconnect 617 is implemented with microbumps, a plurality of metal pillars, or a hybrid bonded connection, among others that would be apparent to those skilled in the art of semiconductor interconnects. While mixing and matching physical interconnect type, practicalities suggest that they will match, for example, if microbumps are used for the TSVs, microbumps may likely also be used for the physical interconnect 617 as well. In this way, when the final VM die 140N folds the data into the NVM die 130, the data is passed directly over the physical interconnect 617 to the NVM die 130 from the final VM die 140N. More specifically, the command logic 422 is configured to identify the write command, extract the physical address from the write command, and fold the data, over the physical interconnect 617, to a location associated with the physical address in the NVM die 130.

FIG. 6B is example flow chart illustrating a method 600B for folding data from the VM die to the NVM die over the physical interface 617 according to some embodiments. The method 500B may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 500B is performed by the controller 122 of FIG. 5A or other control logic that may not be a full controller. In embodiments, the method 500B is also performed by the command logic 422.

Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 670, the processing logic receives data from the GPU 112, e.g., over one or more physical interfaces that interconnect the compute die 110 with the logic die 120.

At operation 675, the processing logic writes data over the first plurality of TSVs 170A-170Z to the dedicated VM dies 140A, e.g., which serves as a buffer VM die. In embodiments, the processing logic transmits the data with a write command that includes a physical address in the NVM device 130, which describes a destination location for folding the data to the NVM device 130.

At operation 590, to complete the folding of the data, the processing logic (e.g., the CMD logic 422) folds the data, over the physical interface 617, to the physical address of the NVM die 130.

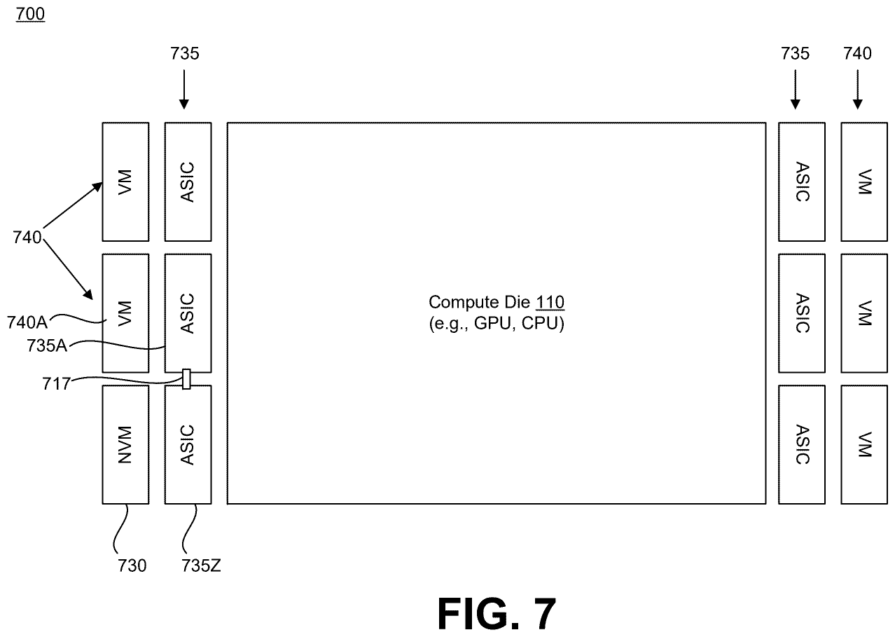

FIG. 7 is an example high-level component diagram of a hybrid VM/NVM compute device 700 (or system) implemented with a sideband interconnect 717 between application-specific integrated circuits (ASICs) so that data can be folded from a VM die to a NVM die according to some embodiments. For example, the compute device 700 can include a compute die 100 (e.g., GPU 112 and/or CPU 114), the plurality of VM dies 140 coupled to the compute die 110 through a corresponding plurality of application-specific integrated circuits or ASICs 735. A non-volatile memory (NVM) die 730 can be coupled to the compute die 110 through a final ASIC 735Z. The sideband interconnect 717 can be coupled between the final ASIC 735Z and a first ASIC 735A, of the plurality of ASICs 735, that is coupled to a first VM die 740A of the plurality of VM dies 740. In some embodiments, the compute die 110 writes data to the first VM die 140A through the first ASIC 735A and transmits, over the first ASIC 735A, a write command including a physical address. In embodiments, the write command is configured to cause the first VM die 740A to fold the data, over the sideband interconnect 717, to the physical address of the NVM die 130.

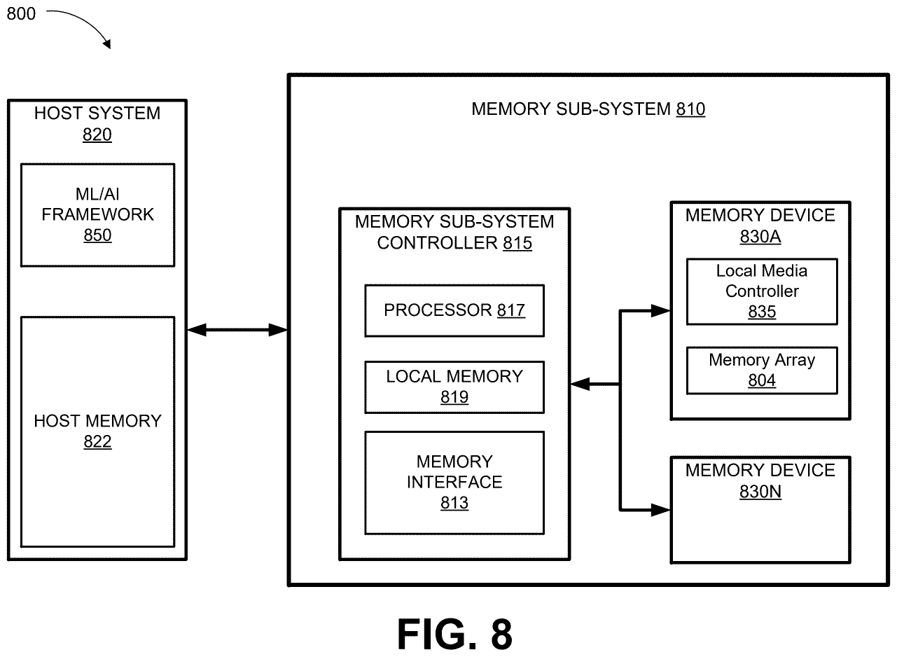

FIG. 8 illustrates a high-level component diagram of an example computing system 800 that includes a memory sub-system 810 in accordance with some implementations of the present disclosure. The memory sub-system 810 can include one or more memory devices 830A-830N, which may include one or more volatile memory devices, and/or one or more non-volatile memory devices. In an illustrative example, any combination of the one or more memory devices 830A-830N may be represented by any of the compute devices disclosed and described herein.

The memory sub-system 810 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 800 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 800 can include a host system 820 that is coupled to one or more memory sub-systems 830. In some implementations, the host system 820 is coupled to different types of memory sub-system 810. FIG. 8 illustrates one example of a host system 820 coupled to one memory sub-system 810. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 820 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 820 uses the memory sub-system 810, for example, to write data to the memory sub-system 810 and read data from the memory sub-system 810.

The host system 820 can be coupled to the memory sub-system 810 via a physical host interface. Examples of physical host interfaces include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 820 and the memory sub-system 810. The host system 820 can further utilize an NVM Express (NVMe) interface to access the memory components (e.g., the one or more memory device(s) 830) when the memory sub-system 810 is coupled with the host system 820 by the physical host interface (e.g., PCIe or CXL bus). The physical host interface can provide an interface for passing control, address, data, and other signals between the memory sub-system 810 and the host system 820. FIG. 8 illustrates a memory sub-system 810 as an example. In general, the host system 820 can access multiple memory sub-systems via a same communication connection, multiple separate communication connections, and/or a combination of communication connections.

The memory devices 830A-830N can include any combination of the different types of non-volatile memory devices and/or volatile memory devices. In an illustrative example, one or more memory devices 830A-830N may be represented by any of the compute devices illustrated and described herein.

The volatile memory devices can be, e.g., random access memory (RAM), such as dynamic random access memory (DRAM) and synchronous dynamic random access memory (SDRAM). Some examples of non-volatile memory devices include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

A memory device 830A-830N can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some implementations, each of the memory devices 830A-830N can include one or more arrays of memory cells such as SLCs, MLCs, TLCs, QLCs, or any combination of such. In some implementations, a particular memory device can include an SLC portion, and an MLC portion, a TLC portion, or a QLC portion of memory cells. The memory cells of the memory devices 830A-830N can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory devices 830A-830N can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 815 can communicate with the memory device(s) 830A-830N to perform operations such as reading data, writing data, or erasing data at the memory devices 830A-830N and other such operations. The memory sub-system controller 815 can include hardware such as one or more integrated circuits and/or discrete components, a buffer memory, or a combination thereof. The hardware can include a digital circuitry with dedicated (i.e., hard-coded) logic to perform the operations described herein. The memory subsystem controller 815 can be a microcontroller, special purpose logic circuitry (e.g., a field programmable gate array (FPGA), an application specific integrated circuit (ASIC), etc.), or other suitable processor.

The memory sub-system controller 815 can include a processor 817 (e.g., a processing device) configured to execute instructions stored in a local memory 819. In the illustrated example, the local memory 819 of the memory sub-system controller 815 includes an embedded memory configured to store instructions for performing various processes, operations, logic flows, and routines that control operation of the memory sub-system 810, including handling communications between the memory sub-system 810 and the host system 820.

In some implementations, the local memory 819 can include memory registers storing memory pointers, fetched data, etc. The local memory 819 can also include read-only memory (ROM) for storing micro-code. While the example memory sub-system 810 in FIG. 8 has been illustrated as including the memory sub-system controller 815, in another implementation of the present disclosure, a memory sub-system 810 does not include a memory sub-system controller 815, and can instead rely upon external control (e.g., provided by an external host, or by a processor or controller separate from the memory sub-system).

In general, the memory sub-system controller 815 can receive commands or operations from the host system 820 and can convert the commands or operations into instructions or appropriate commands to achieve the desired access to the memory device(s) 830. The memory sub-system controller 815 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 830A-830N. The memory sub-system controller 815 can further include host interface circuitry to communicate with the host system 820 via the physical host interface. The host interface circuitry can convert the commands received from the host system into command instructions to access the memory device(s) 830A-830N as well as convert responses associated with the memory device(s) 830A-830N into information for the host system 820.

The memory sub-system 810 can also include additional circuitry or components that are not illustrated. In some implementations, the memory sub-system 810 can include a cache or buffer (e.g., DRAM) and address circuitry (e.g., a row decoder and a column decoder) that can receive an address from the memory sub-system controller 815 and decode the address to access the memory device(s) 830.

In some implementations, the memory device(s) 830A-830N include local media controllers 835 that operate in conjunction with memory sub-system controller 815 to execute operations on one or more memory cells of the memory device(s) 830A-830N. An external controller (e.g., memory sub-system controller 815) can externally manage the memory device 830A-830N (e.g., perform media management operations on the memory device(s) 830A-830N). In some implementations, a memory device 830A-830N is a managed memory device, which is a raw memory device (e.g., memory array 804) having control logic (e.g., local controller 835) for media management within the same memory device package. An example of a managed memory device is a managed NAND (MNAND) device. Memory device(s) 830A-830N, for example, can each represent a single die having some control logic (e.g., local media controller 835) embodied thereon. In some implementations, the local media controller 835 may be represented by the controller 122 (or control logic) of any of FIGS. 1A, 2A, 3A, 4A, 5A, or 6A or the command logic 422 of any of FIGS. 4A, 5A, or 6A.

In some implementations, the memory sub-system 810 includes a memory interface 813 that is responsible for handling interactions of memory sub-system controller 815 with the memory devices of memory sub-system 810, such as memory devices 830A-830N. For example, the memory interface 813 can send or transmit memory access commands corresponding to requests received from host system 820 to memory devices 830A-830N, such as program commands, read commands, or other commands. In addition, the memory interface 813 can receive data from devices 830A-830N, such as data retrieved in response to a read command or a confirmation that a program command was successfully performed. In some implementations, the memory sub-system controller 815 includes at least a portion of the memory interface 813. For example, the memory sub-system controller 815 can include a processor 817 (processing device) configured to execute instructions stored in local memory 819 for performing the operations described herein.

In some implementations, the host system 820 implements an ML/AI framework 850. ML/AI framework 850 can include one or more ML models, a processing engine, and a training engine, among other components, which can be used to perform any automated task (e.g., classify or categorize documents or images). In order to train the one or more ML models, ML/AI framework 850 can issue requests to read the training data, which may be stored on one or more memory devices 830A-830N, and process the training data accordingly. In some implementations, ML/AI framework 850 is executed by multiple processing units (e.g., GPUs and/or CPUs) which can process many threads/streams in parallel.

In some implementations, host system 820 could include hundreds of parallel processing threads that can request and process different subsets of the training data concurrently. In some implementations, at least some of the processing tasks of the ML/AI framework 850 are performed by the compute die 110 of the compute device (FIGS. 1A, 2A, 3A, 4A, 5A, 6A) or by the processing units 512, 514 residing on any of the hybrid memory devices described herein. In embodiments, one or more of the compute device or the hybrid memory devices are employed by the memory sub-system as memory devices 830A-830N.

Once a certain amount of training is complete, ML/AI framework 850 can enter an inference phase to analyze different input data. The input data can similarly be stored on memory devices 830A-830N of the same or a different memory sub-system 810. In some implementations, ML/AI framework 850 can issue requests to read the input data from memory sub-system 810 and store a copy of the input data in the host memory 822.

In some implementations, the host system 820 utilizes a set of queues to track the memory access commands issued to the memory sub-system 810 (e.g., requests to read data for ML/AI framework 850). For example, the host system 820 can include a number of submission queues, storing submission queue entries representing the memory access commands issued to the memory sub-system 810, and a number of completion queues, storing completion queue entries received from the memory sub-system 810 to indicate that the corresponding memory access commands have been executed. In some implementations, the host system 820 can maintain these queues in the host memory 822.

The host memory 822 may include one or more DRAM devices, HBM devices, and/or other types of memory devices. In some implementations, the host memory 822 includes the compute device of any of FIGS. 1A, 2A, 3A, 4A, 5A, or 6A.

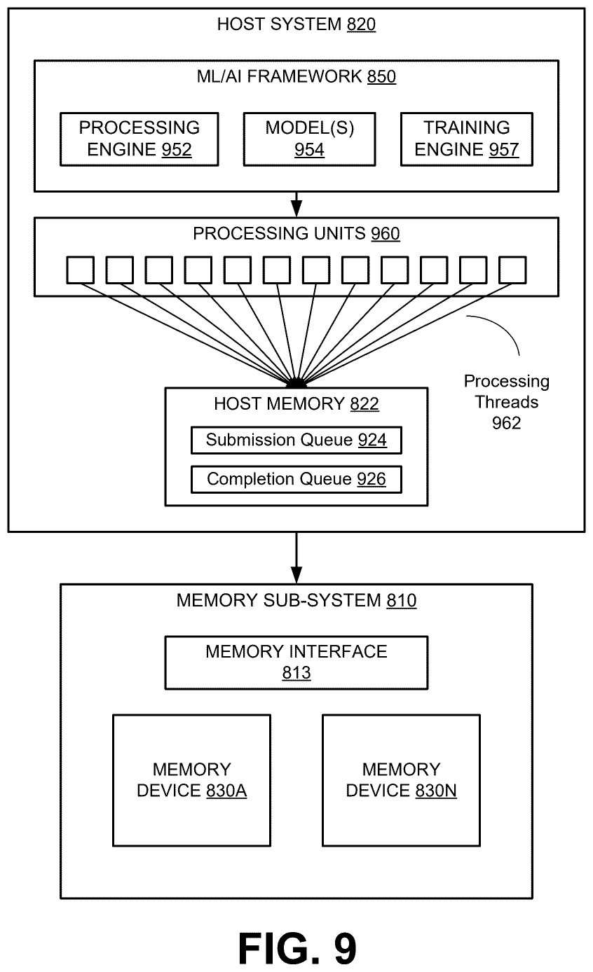

FIG. 9 is a block diagram illustrating a system for performing AI model inference operations using memory devices and/or host systems implemented in accordance with aspects of the present disclosure. As illustrated, host system 820 includes ML/AI framework 850 which can be executed by a number of processing threads 962. Host system 820 further includes host memory 822, including submission queues 924 and completion queues 946. In some implementations, ML/AI framework 850 includes a processing engine 952, one or more machine learning models 954, and a training engine 956, among other components, which can be used to perform any automated task (e.g., classify or categorize documents or images). Depending on the implementation one or more components that make up ML/AI framework 850 can be distributed across multiple different computing devices (e.g., host computers, servers, etc.). In some implementations, processing engine 952 may use a set of trained machine learning models 954 that are trained and used to perform any number of automated operations. The processing engine 952 may also preprocess any received input data prior to using the data for training of the set of machine learning models 954 and/or applying the set of trained machine learning models 954 to the input data. Based on the output of the set of trained machine learning models 954, the processing engine 952 may obtain, for example, a classification and/or category of the input data, as well an assessment of the classification.

In some implementations, at least some of the processing tasks of the ML/AI framework 850 are performed by the compute die 110 (e.g., the GPU 112 and/or CPU 114) residing on the compute device 100A of FIG. 1. In embodiments, the compute device 100A is employed by the memory sub-system 810 as memory devices 830A-830N.

The set of machine learning models 974 may refer to model artifacts that are created by the training engine 956 using training data that includes training inputs and corresponding target outputs (i.e., correct answers for respective training inputs). During training, patterns in the training data that map the training input to the target output (i.e., the answer to be predicted) can be found, and are subsequently used by the machine learning models 954 for future predictions. Depending on the implementation, the set of machine learning models 954 may be composed of, for example, a single level of linear or non-linear operations (e.g., a support vector machine [SVM]) or may be a deep network, (i.e., a machine learning model that is composed of multiple levels of non-linear operations). Examples of deep networks are neural networks including convolutional neural networks, recurrent neural networks with one or more hidden layers, and fully connected neural networks.

Thus, in order to train and utilize the one or more machine learning models 954, ML/AI framework 850 can issue requests to read training data and input data, which may be stored on memory device 830A-830N of memory sub-system 810, and process the data accordingly. In some implementations, these memory access requests are sent by the parallel processing threads 962 being executed by respective processing units 960. The processing units 960 can include a number of general-purpose processing devices such as microprocessors, central processing units (CPUs), or the like, or more specialized processing devices, such as graphics processing units (GPUs), which may be optimized for performing high-speed sequential processing operations. Thus, at least some of the processing units 960 may be the compute device of any of FIGS. 1A, 2A, 3A, 4A, 5A, or 6A.

Depending on the implementation there can be any number of processing units 960 (e.g., tens or hundreds), each executing a respective one or more of the processing threads 962. Each processing thread 962 represents a series of sequential operations directed to memory subsystem 810 (e.g., read requests for separate segments of an element of training or input data stored at memory sub-system 810). Due to the large relative size of the training data or input data, each element may be broken up into separate segments of a smaller fixed size and stored at sequential memory addresses in memory sub-system 810. Thus, in order to read the entire element of data, a sequence of multiple read requests can be issued to obtain all of the separate segments. Each processing thread 962 can include a series of read requests to read the segments of a different element of data from memory sub-system 810. Upon the read requests from each processing thread 962 being generated, the requests can be stored as entries in one of submission queues 924, from which they can be issued to memory sub-system 810. Received responses to the requests from memory sub-system 810 can be stored as entries in one of completion queues 946, retrieved by processing threads 962 and provided to ML/AI framework 850 for execution in either a training phase or an inference phase.

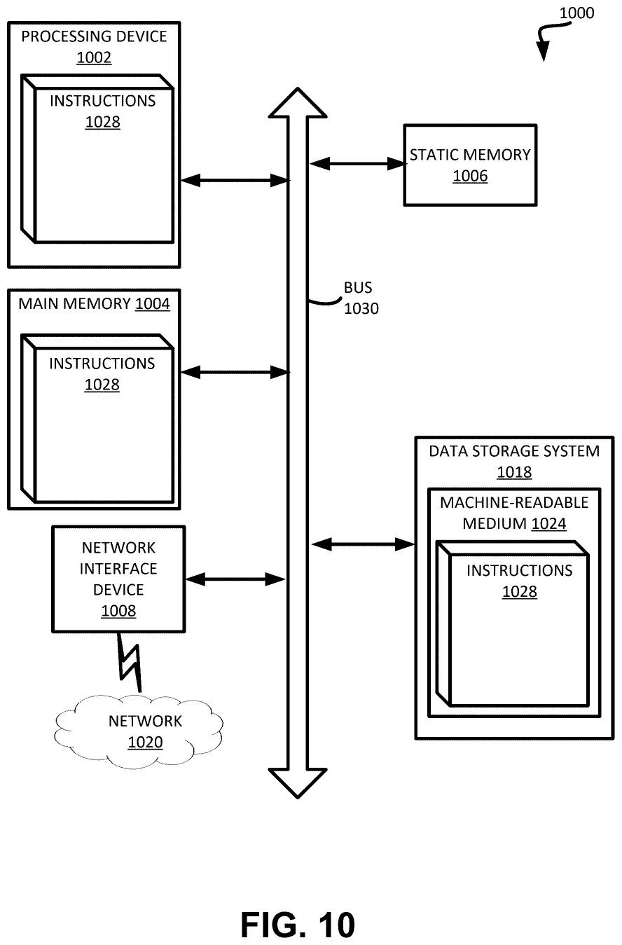

FIG. 10 illustrates an example machine of a computer system 1000 within which a set of instructions, for causing the machine to perform any one or more of the methodologies discussed herein, can be executed. In some implementations, the computer system 1000 can correspond to a host system (e.g., the host system 820 of FIG. 8) that includes, is coupled to, or utilizes a memory sub-system (e.g., the memory sub-system 810 of FIG. 8) or can be used to perform the operations of a controller (e.g., to execute an operating system to perform operations corresponding to the memory interface 813 or memory sub-system controller 815 of FIG. 8). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage system 1018, which communicate with each other via a bus 1030.

Processing device 1002 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 can also be one or more special-purpose processing devices such as an application specific integrated circuit (ASIC), a field programmable gate array (FPGA), a digital signal processor (DSP), network processor, or the like. The processing device 1002 is configured to execute instructions 1028 for performing the operations and steps discussed herein. The computer system 1000 can further include a network interface device 1008 to communicate over the network 1020.

The data storage system 1018 can include a machine-readable storage medium 1024 (also known as non-transitory computer-readable storage medium) on which is stored one or more sets of instructions 1028 (executable instructions) or software embodying any one or more of the methodologies or functions described herein. The instructions 1028 can also reside, completely or at least partially, within the main memory 1004 and/or within the processing device 1002 during execution thereof by the computer system 1000, the main memory 1004 and the processing device 1002 also constituting machine-readable storage media. The machine-readable storage medium 1024, data storage system 1018, and/or main memory 1004 can correspond to the memory sub-system 810 of FIG. 8. In some implementations, the data storage system 1018 may include the any compute device disclosed herein in any of FIGS. 1A, 2A, 3A, 4A, 5A, or 6A.

In some implementations, the instructions 1028 include instructions to implement functionality corresponding to the memory interface 813 of FIG. 8). While the machine-readable storage medium 1024 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A compute device comprising:
one or more volatile memory (VM) dies stacked with a non-volatile memory (NVM) die;
a logic die comprising control logic, wherein the logic die is also stacked with the one or more VM dies and the NVM die; and
a first plurality of through-silicon vias (TSVs) formed through the one or more VM dies and the NVM die, wherein the first plurality of TSVs are intercoupled through a plurality of microbumps; and
wherein the control logic is configured to perform operations comprising:
writing data to and reading data from the one or more VM dies through a first subset of the first plurality of TSVs; and
folding the data from the one or more VM dies to the NVM die through a second subset of the first plurality of TSVs that are fewer than the first subset and are dedicated to the folding of the data.

2. The compute device of claim 1, further comprising:
the plurality of microbumps; and
an additional plurality of microbumps to interconnect TSVs of the NVM die to TSVs of the logic die.

3. The compute device of claim 1, further comprising:
a second plurality of TSVs formed through the one or more VM dies and the NVM die; and
a second plurality of microbumps to interconnect the second plurality of TSVs; and
wherein the control logic is configured to perform the folding through the second plurality of TSVs.

4. The compute device of claim 3, wherein the first plurality of TSVs form a plurality of channels, and wherein the second plurality of TSVs comprise a single channel configured to transfer the data at a slower rate than that of the first plurality of TSVs.

5. The compute device of claim 1, further comprising:
a second plurality of TSVs formed through the NVM die and a first VM die of the one or more VM dies that is stacked physically closest to the logic die; and
a second plurality of microbumps to interconnect the second plurality of TSVs; and
wherein the control logic is configured to perform the folding through the second plurality of TSVs.

6. The compute device of claim 5, wherein the first plurality of TSVs form a plurality of channels, and wherein the second plurality of TSVs comprise a single channel configured to transfer the data at a slower rate than that of the first plurality of TSVs.

7. A compute device comprising:
one or more volatile memory (VM) dies stacked with a non-volatile memory (NVM) die;
a logic die comprising control logic, wherein the logic die is also stacked with the one or more VM dies and the NVM die; and
a first plurality of through-silicon vias (TSVs) formed through the one or more VM dies and the NVM die; and
a second plurality of TSVs formed through the NVM die and a first VM die, of the one or more VM dies, that is stacked physically closest to the logic die; and
wherein the control logic is configured to perform operations comprising:
writing data to the first VM die through the first plurality of TSVs; and
transmitting, over the first plurality of TSVs to the first VM die, a write command comprising a physical address and configured to cause the first VM die to fold the data, over the second plurality of TSVs, to the physical address of the NVM die.

8. The compute device of claim 7, wherein:
the first plurality of TSVs are interconnected through a first plurality of microbumps; and
the second plurality of TSVs are interconnected through a second plurality of microbumps.

9. The compute device of claim 7, wherein the second plurality of TSVs are also formed through one or more additional VM dies, and wherein transmitting the write command is to the one or more additional VM dies, which are also configured to fold the data to the NVM die.

10. The compute device of claim 7, wherein the operations further comprise:
selecting, from a command table, the write command that is to direct the first VM die to perform folding of the data to the NVM die; and
populating the write command with the physical address to which the data is to be folded in the NVM die.

11. The compute device of claim 7, wherein the first VM die comprises command logic configured to identify the write command, extract the physical address, and fold the data, over the second plurality of TSVs, to a location associated with the physical address in the NVM die.

12. A compute device comprising:
a plurality of volatile memory (VM) dies stacked with a non-volatile memory (NVM) die, wherein the plurality of VM dies are face-down towards the NVM die;
a physical interconnect coupled between the NVM die and a first VM die, of the plurality of VM dies, stacked physically closest to the NVM die;
a logic die comprising control logic, wherein the logic die is also stacked with the plurality of VM dies and the NVM die; and
a plurality of through-silicon vias (TSVs) formed through the logic die, the plurality of VM dies, and the NVM die; and
wherein the control logic is configured to perform operations comprising:
writing data to the first VM die through the plurality of TSVs; and
transmitting, over the plurality of TSVs to the first VM die, a write command comprising a physical address and configured to cause the first VM die to fold the data, over the physical interconnect, to the physical address of the NVM die.

13. The compute device of claim 12, wherein the plurality of TSVs are interconnected through a first plurality of microbumps, and wherein the physical interconnect comprises one of a second plurality of microbumps, a plurality of metal pillars, or a hybrid bonded connection.

14. The compute device of claim 12, wherein the operations further comprise:
selecting, from a command table, the write command that is to direct the first VM die to perform folding of the data to the NVM die; and
populating the write command with the physical address to which the data is to be folded in the NVM die.

15. The compute device of claim 12, wherein the first VM die comprises command logic configured to identify the write command, extract the physical address from the write command, and fold the data, over the physical interconnect, to a location associated with the physical address in the NVM die.

16. A compute device comprising:
a plurality of volatile memory (VM) dies stacked with a non-volatile memory (NVM) die, wherein the NVM die is stacked face-down on top of the plurality of VM dies;
a physical interconnect coupled between the NVM die and a first VM die, of the plurality of VM dies, stacked physically closest to the NVM die;
a logic die comprising control logic, wherein the logic die is also stacked with the plurality of VM dies and the NVM die; and
a plurality of through-silicon vias (TSVs) formed through the logic die and plurality of VM dies; and
wherein the control logic is configured to perform operations comprising:
writing data to the first VM die through the plurality of TSVs; and
transmitting, over the plurality of TSVs to the first VM die, a write command comprising a physical address and configured to cause the first VM die to fold the data, over the physical interconnect, to the physical address of the NVM die.

17. The compute device of claim 16, wherein the plurality of TSVs are interconnected through a first plurality of microbumps, and wherein the physical interconnect comprises one of a second plurality of microbumps, a plurality of metal pillars, or a hybrid bonded connection.

18. The compute device of claim 16, wherein the operations further comprise:
selecting, from a command table, the write command that is to direct the first VM die to perform folding of the data to the NVM die; and
populating the write command with the physical address to which the data is to be folded in the NVM die.

19. The compute device of claim 16, wherein the first VM die comprises command logic configured to identify the write command, extract the physical address from the write command, and fold the data, over the physical interconnect, to a location associated with the physical address in the NVM die.

20. A compute device comprising:
a compute die;
a plurality of volatile memory (VM) dies coupled to the compute die through a corresponding plurality of application-specific integrated circuits (ASICs);
a non-volatile memory (NVM) die coupled to the compute die through a final ASIC; and
a sideband interconnect coupled between the final ASIC and a first ASIC, of the plurality of ASICs, that is coupled to a first VM die of the plurality of VM dies; and
wherein the compute die is to perform operations comprising:
writing data to the first VM die through the first ASIC; and
transmitting, over the first ASIC, a write command comprising a physical address and configured to cause the first VM die to fold the data, over the sideband interconnect, to the physical address of the NVM die.
